(19) United States
(12) Patent Application Publication
(10) Pub. No.: US 2002/0040296 A1
(43) Pub. Date: Apr. 4, 2002

(54) Phoneme assigning method

(76) Inventor: Anne Kienappel, Aachen (DE)

Correspondence Address: U.S. Philips Corporation, 580 White Plains Road, Tarrytown, NY, 10591, US

(21) Appl. No.: 09/930,714

(22) Filed: Aug. 15, 2001

(30) Foreign Application Priority Data
Aug. 16, 2000 (DE) 10040063.9

(51) Int. Cl. G10L 19/08; G10L 19/04; G10L 21/00

(52) U.S. Cl. 704/220

(57) ABSTRACT

A description is given of a method of assigning phonemes (Pₖ) of a target language to a respective basic phoneme unit (PE_{Z}(Pₖ)) of a set of basic phoneme units (PE₁, PE₂, . . . , PE_{N}) which are described by respective basic phoneme models, which models were generated via the use of available speech data of a source language. For this purpose, in a first step of the method at least two different speech data controlled assigning methods (1, 2) are used for assigning the phonemes (Pₖ) of the target language to a respective basic phoneme unit (PEᵢ(Pₖ), PEⱼ(Pₖ)). Subsequently, in a second step there is detected whether the respective phoneme (Pₖ) was correspondingly assigned to the same basic phoneme unit (PEᵢ(Pₖ), PEⱼ(Pₖ)) by a majority of the various speech data controlled assigning methods. If there is a largely matching assignment by the various speech data controlled assigning methods (1, 2), the basic phoneme unit (PEᵢ(Pₖ), PEⱼ(Pₖ)) assigned by the majority of the speech data controlled assigning methods (1, 2) is selected as the basic phoneme unit (PE_{z}(Pₖ)) assigned to the respective phoneme (Pₖ). On the other hand, from all the basic phoneme units (PEᵢ(Pₖ), PEⱼ(Pₖ)) that were assigned to the respective phoneme (Pₖ) by at least one of the various speech data controlled assigning methods (1, 2), one basic phoneme unit is selected while a degree of similarity is used in accordance with a symbol-phonetic description of the assigned phoneme (Pₖ) and of the basic phoneme units (PEᵢ(Pₖ), PEⱼ(Pₖ)).

The invention relates to a method of assigning phonemes of a target language to a respective basic phoneme unit of a set of basic phoneme units, which phoneme units are described by basic phoneme models, which models were generated based on available speech data of a source language. In addition, the invention relates to a method of generating phoneme models for phonemes of a target language, a set of linguistic models to be used in automatic speech recognition systems and a speech recognition system containing a respective set of acoustic models.

Speech recognition systems generally work in the way that first the speech signal is analyzed spectrally or in a time-dependent manner in an attribute analysis unit. In this attribute analysis unit the speech signals are customarily divided into sections, so-called frames. These frames are then coded and digitized in suitable form for the further analysis. An observed signal may then be described by a plurality of different parameters or in a multidimensional parameter space by a so-called “observation vector”. The actual speech recognition i.e. the recognition of the semantic content of the speech signal then takes place in that the sections of the speech signal described by the observation vectors or a whole sequence of observation vectors, respectively, is compared with models of different, practically possible sequences of observations and a model is thus selected that matches best with the observation vector or sequence found. For this purpose, the speech recognition system is to comprise a sort of library of the widest variety of possible signal sequences from which the speech recognition system can then select the respectively matching signal sequence. This means that the speech recognition system has the disposal of a set of acoustic models which, in principle, could practically occur for a speech signal. This may be, for example, a set of phonemes or phoneme-like units, diphones or triphones, for which the model of the phoneme depends on respective preceding and/or following phonemes in a context, but there may also be complete words. This may also be a mixed set of the various acoustic units.

Furthermore, a pronunciation lexicon for the respective language and also, to improve the recognition efficiency, various word lexicons, stochastic speech models and grammar guidelines of the respective language are necessary, which define certain practical restrictions when the sequence of successive models is selected. Such restrictions, on the one hand, improve the quality of the recognition and, on the other hand, provide considerable acceleration, because these restrictions provide that only certain combinations of observation sequences are considered.

A method of describing acoustic units i.e. certain sequences of observation vectors is the use of so-called “Hidden Markov Models” (HM models). They are stochastic signal models for which it is assumed that a signal sequence is based on a so-called Markov chain of various states with transition probabilities between the individual states. The respective states themselves cannot be detected then (are hidden) and the occurrence of the actual observations in the individual states is described by a probability function as a function of the respective state. A model for a certain sequence of observations can therefore be described in this concept, in essence, by the sequence of the various continuous states, by the duration of the stop in the respective states, the transition probability between the states and by the probability of occurrence of the individual observations in the respective states. A model for a certain phoneme is then generated, so that first suitable initial parameters for a model are used and then, in a so-called training, this model is adapted to the respective language phoneme to be modeled by a change of the parameters, so that an optimal model is found. For this training i.e. the adaptation of the models to the actual phonemes of a language, an adequate number of qualitatively good speech data of the respective language are necessary. The details about the various HM models as well as the exact parameters to be adapted do not individually play an essential role for the present invention and are therefore not described in further detail.

When a speech recognition system is trained based on phoneme models (for example, said Hidden Markov Models) for a new target language, for which there is unfortunately only little original spoken material available, spoken material of other languages may be used to support the training. For example, first HM models can be trained in another source language that differs from the target language, and these models are then transferred to the new language as basic models and adapted to the target language with the available speech data of the target language. Meanwhile, it has turned out that first a training of models for multilingual phoneme units, which are based on a plurality of source languages, and an adaptation of these multilingual phoneme units to the target language, yields better results than the use of only monolingual models of a source language (T. Schultz and A. Waibel in “Language Independent and Language Adaptive Large Vocabulary Speech Recognition”, Proc. ICSLP, pp. 1819-1822, Sidney, Australia 1998).

For the transfer is necessary an assignment of the phonemes of the new target language to the phoneme units of the source language or to the multilingual phoneme units, respectively, which takes into account the acoustic similarity of the respective phonemes or phoneme units. The problem of assigning the phonemes of the target language to the basic phoneme models is then closely related to the problem of the definition of the basic phoneme units themselves, because not only the assignment to the target language, but also the definition of the basic phoneme units themselves is based on acoustic similarity.

For evaluating the acoustic similarity of phonemes of different languages, basically phonetic background knowledge can be used. For this purpose, an assignment of the phonemes of the target language to the basic phoneme units is in principle possible on the basis of this background knowledge. Phonetics expertise of the respective languages is necessary then. Such expertise is relatively costly, however.

For lack of sufficient expertise, international phonetic transcriptions, for example IPA or SAMPA, are therefore often fallen back on for assigning the phonemes to the target language. This type of assignment is then unambiguous if the basic phoneme units themselves can unambiguously be assigned to an international phonetic transcription symbol. For the multilingual phoneme units mentioned above, this is only given when the phoneme units of the source languages themselves are based on a phonetic transcription. To obtain a simple reliable assigning method for the target language, the basic phoneme units could therefore also be defined while phoneme symbols of an international phonetic transcription are used. These phoneme units, however, are less suitable for a speech recognition system than phoneme units which are generated by means of statistical models of available real speech data.

However, particularly for such multilingual basic phoneme units, which were generated based on the speech data of the source languages, the assignment by means of a phonetic transcription is not completely unambiguous. A clear phonologic identity of such units is not guaranteed. Therefore, a knowledge-based assignment off the cuff is also very hard for a phonetics expert.

In principle, there is a possibility of automatically assigning the phonemes of the target language to the basic phoneme models also on the basis of speech data and their statistical models. A quality of such speech data controlled assigning methods, however, critically depends on the fact that there are enough speech data in the language, whose phonemes are to be assigned to the models. This, however, is not absolutely a given fact for the target language. Therefore, however, there is no simple reliable assigning method for such target language phoneme units that are generated via a speech data controlled definition.

It is an object of the present invention to provide an alternative to the known state of the art, which alternative permits a simple and reliable assignment of phonemes of a target language to arbitrary basic phoneme units, more particularly, also to multilingual phoneme units generated via a speech data controlled definition. This object is achieved with a method as claimed in patent claim 1.

For the method according to the invention are then necessary at least two, if possible, even still more, different speech data controlled assigning methods. They should be complementary speech data controlled assigning methods which each work in a completely different manner.

With these different speech data controlled assigning methods each phoneme of the target language is then handled in such manner that the phoneme is assigned to a respective basic phoneme unit. After this step there is one basic phoneme unit available from each speech data controlled method, which unit is assigned to the respective phoneme. These basic phoneme units are compared to detect whether each time the same basic phoneme units are assigned to the phoneme. If the majority of the speech data controlled assigning methods yield a corresponding result, this assignment is selected i.e. particularly the very basic phoneme unit that is selected most by the automatic speech data controlled method is assigned to the phoneme. If no majority of the various methods yield corresponding results, for example, if two different speech data controlled assigning methods are used, these two assigning methods have assigned different basic phoneme units to the phonemes, the very basic phoneme unit that has a certain similarity to a symbol phonetic description of the phoneme to be assigned and is the best match for the respective basic phoneme units, is selected from the various assignments.

The advantage of the method according to the invention is then that the method permits optimum use of speech data material, if available, (thus particularly on the side of the source languages when the basic phoneme units are defined), and only then falls back on phonetic or linguistic background knowledge when the data material is insufficient to determine an assignment with sufficient confidence. The degree of confidence is here the matching of the results of the various speech data controlled assigning methods. In this manner also the advantages of data controlled definition methods can be used for multilingual phoneme units in the transfer to new languages. The implementation of the method according to the invention, however, is not restricted to HM models or to multilingual basic phoneme units, but may also be useful with other models and, naturally, also for the assignment of monolingual phonemes or phoneme units, respectively. In the following, however, a set of multilingual phoneme units is used as a basis, for example, which units are each described by HM models.

The knowledge-based (based on phonetic background knowledge) assignment in the case of insufficient confidence is extremely simple, because a selection is to be made only from a very limited number of possible solutions which are already predefined by the speech data controlled method. It is then obvious that the degree of similarity according to the symbol phonetic descriptions includes information about the assignment of the respective phoneme and the assignment of the respective basic phoneme units to phoneme symbols and/or phoneme classes of a predefined, preferably international phonetic transcription such as SAMPA or IPA. Only representation in phonetic transcription of the phonemes of the languages involved as well as an assignment of the phonetic transcription symbols to phonetic classes is needed here. The selection from the basic phoneme units already selected by the speech data controlled assigning method, which selection is based on the pure phoneme symbol match and phoneme class match, of the “right” assignment to the target language phoneme to be assigned is based on a very simple criterion and does not need any linguistic expert knowledge. Therefore, it may be realized without any problem by means of suitable software on any computer, so that the whole assigning method according to the invention can advantageously be executed fully automatically.

There are various possibilities for the speech data controlled assigning method:

With a first speech data controlled assigning method, first phoneme models for the individual phonemes of the target language are generated while speech data are used i.e. models are trained to the target language and the available speech material of the target language is used. For the generated models is then determined a respective difference parameter for the various basic phoneme models of the respective basic phoneme units of the source languages. This difference parameter may be, for example, a geometric distance in the multidimensional parameter space of the observation vectors mentioned in the introductory part. The very basic phoneme unit that has the smallest difference parameter is assigned to the phoneme, that is to say, the nearest basic phoneme unit is taken.

With another speech data controlled assigning method, first the available speech data material of the target language is subdivided into so-called phoneme-start and phoneme-end segmenting. With the aid of phoneme models of a defined phonetic transcription, for example, SAMPA or IPA, the speech data are segmented into individual phonemes. These phonemes of the target language are then fed to the speech recognition system which works on the basis of the set of the basic phoneme units to be assigned or on the basis of their basic phoneme models, respectively. In the speech recognition system are customarily determined recognition values for the basic phoneme models, which means, there is established with what probability a certain phoneme is recognized as a certain basic phoneme unit. To each phoneme is then assigned the basic phoneme unit whose basic phoneme model has the best recognition rate. Worded differently: To the phoneme of the target language is assigned the very basic phoneme unit that the speech recognition system has recognized the most during the analysis of the respective target language phoneme.

The method according to the invention enables a relatively fast and good generation of phoneme models for phonemes of a target language to be used in automatic speech recognition systems, in that, according to said method, the basic phoneme units are assigned to the phonemes of the target language and then the phonemes are described by the respective basic phoneme models, which were generated with the aid of extensive available speech data material from different source languages. For each target language phoneme the basic phoneme model is used as a start model, which is finally adapted to the target language with the aid of the speech data material. The assigning method according to the invention is then implemented as a sub-method within the method of generating phoneme models of the target language.

The whole method of generating the phoneme models, including the assigning method according to the invention, can advantageously be realized with suitable software on computers fitted out accordingly. It may also partly be advantageous if certain sub-routines of the method, such as, for example, the transformation of the speech signals into observation vectors, are realized in the form of hardware to obtain higher process speeds.

The phoneme models generated thus can be used in a set of acoustic models which, for example, together with the pronunciation lexicon of the respective target language is available for use in automatic speech recognition systems. The set of acoustic models may be a set of context-independent phoneme models. Obviously, they may also be diphone, triphone or word models, which are formed from the phoneme models. It is obvious that such acoustic models of various phones are usually speech-dependent.

The invention will be further explained in the following with reference to the drawing Figures with the aid of an example of embodiment. The attributes represented hereinbelow and the attribute already described above can be of essence to the invention, not only in said combinations, but also individually or in other combinations.

In the drawings:

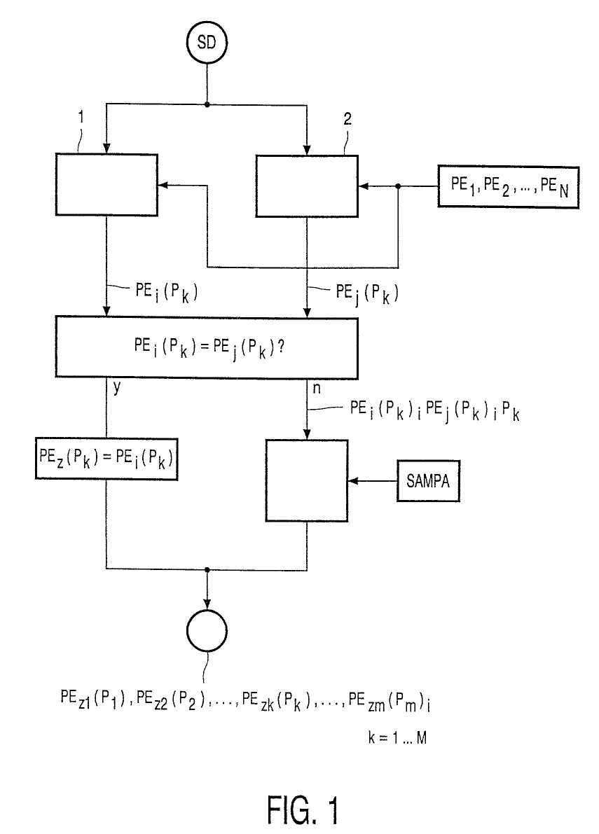

FIG. 1 shows a schematic procedure of the assigning method according to the invention;

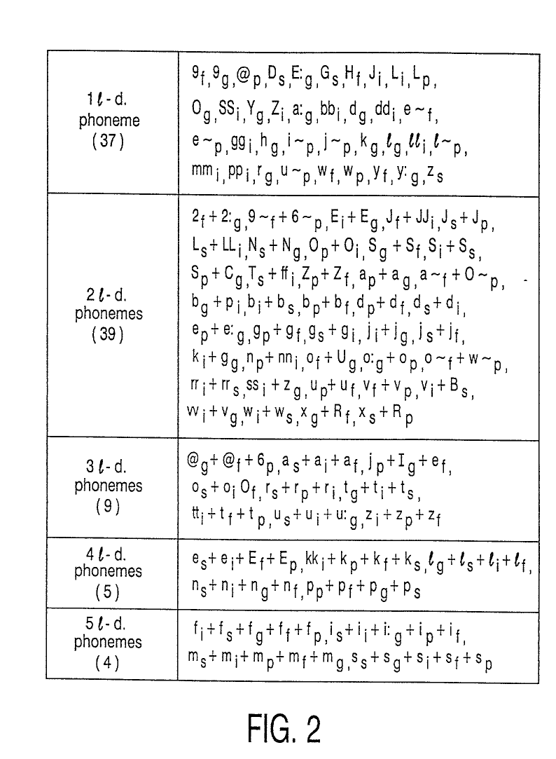

FIG. 2 shows a Table of sets of 94 multilingual basic phoneme units of the source languages French, German, Italian, Portuguese and Spanish.

For a first example of embodiment, a set of N multilingual phoneme units was formed from five different source languages—French, German, Italian, Portuguese and Spanish. For forming these phoneme units from the total of 182 speech-dependent phonemes of the source languages, acoustically similar phonemes were combined and for these speech-dependent phonemes a common model, a multilingual HM model, was trained based on the speech material of the source languages.

To detect which phonemes of the source languages are so similar that they practically form a common multilingual phoneme unit, a speech data controlled method was used.

First a difference parameter D between the individual speech-dependent phonemes is determined. For this purpose, context-independent HM models having N_{S} states per phoneme are formed for the 182 phonemes of the source languages. Each state of a phoneme is then described by a mixture of n Laplace probability densities. Each density j then has the mixing weight wⱼ and is represented by the mean value of N_{F} components and the standard deviation vectors \vec{m}ⱼ and \vec{s}ⱼ. The distance parameter is then defined as:

D(P₁,P₂)=d(P₁,P₂)/2+d(P₂,P₁)/2

where

$$d ( {P}_{1} , {P}_{2} ) = {\sum }_{l = 1}^{{N}_{s}} {\sum }_{i = 1}^{{n}_{1 , l}} {w}_{i}^{( 1 , l )} {min}_{0 < j < {n}_{2 , i}} {\sum }_{k = 1}^{{N}_{F}} \frac{\vert {m}_{i , k}^{( 1 , l )} - {m}_{j , k}^{( 2 , l )} \vert}{{s}_{j , k}^{( 2 , l )}}$$

This definition may also be understood to be a geometric distance.

The 182 phonemes of the source languages were grouped with the aid of the so-defined distance parameter, so that the mean distance between the phonemes of the same multilingual phoneme is minimized.

The assignment is effected automatically with a so-called bottom-up clustering algorithm. The individual phonemes are then combined to clusters one by one in that up to a certain break-off criterion always a single phoneme is added to the nearest cluster. A nearest cluster is here to be understood as the cluster for which the above-defined mean distance is minimal after the single phoneme has been added. Obviously, also two clusters which already consist of a plurality of phonemes can be combined in like manner.

The selection of the above-defined distance parameter guarantees that the multilingual phoneme units generated in the method describe different classes of similar sounds, because the distance between the models depends on the sound similarity of the models.

As a further criterion was given that never two phonemes of the same language are represented in the same multilingual phoneme unit. This means, before a phoneme of a certain source language was assigned to a certain cluster as a nearest cluster, first the test was made whether this cluster already contained a phoneme of the respective language. If this was the case, in a next step a test was made whether an exchange of the two phonemes of the respective language would lead to a smaller mean distance inside the cluster. Only in that case would an exchange be carried out, otherwise the cluster would be left unchanged. A respective test was made before two clusters were blended. This additional limiting condition ensures that the multilingual phoneme units may—as may the phonemes of the individual languages—definition-wise be used for differentiating two words of a language.

Furthermore, a break-off criterion for the cluster method is selected, so that no sounds of remote phonetic classes are represented in the same cluster.

In the cluster method a set of N different multilingual phoneme units was generated, where N may have a value between 182 (the number of the individual language-dependent phonemes) and 50 (the maximum number of phonemes in one of the source languages). In the present example of embodiment, N=94 phoneme units were generated and then the cluster method was broken off.

FIG. 2 shows a Table of this set of a total of 94 multilingual basic phoneme units. The left column of this Table shows the number of phoneme units which are combined from a certain number of individual phonemes of the source languages. The right column shows the individual phonemes (interlinked via a “+”), which form respective groups of basic phonemes, which form each a phoneme unit. The individual language-dependent phonemes are represented here in the international phonetic transcription SAMPA with the index indicating the respective language (f=French, g=German, I=Italian, p=Portuguese, s=Spanish). For example—as can be seen in the bottom row in the right-hand column of the Table in FIG. 2—the phonemes f, m and s in all 5 source languages are acoustically so similar that they form a common multilingual phoneme unit. In all, the set consists of 37 phoneme units which are each defined by only a single language-dependent phoneme, of 39 phoneme units which are each defined by 2 individual language-dependent phonemes, of 9 phoneme units which are each defined by 3 individual language-dependent phonemes, of 5 phoneme units which are each defined by 4 language-dependent phonemes, and of only 4 phoneme units which are each defined by 5 language-dependent phonemes. The maximum number of the individual phonemes in a multilingual phoneme unit is predefined by the number of languages involved—here 5 languages—on account of the above-defined condition that never two phonemes of the same language must be represented in the same phoneme unit.

For the speech transfer of these multilingual phoneme units the method according to the invention is then used with which the phonemes of the target languages, in the present example of embodiment English and Danish, are assigned to the multilingual phoneme units of the set shown in FIG. 2.

The method according to the invention is independent of the respective concrete set of basic phoneme units. At this point it is expressly stated that the grouping of the individual phonemes to form the multilingual phonemes may also be performed with another suitable method. More particularly, also another suitable distance parameter or similarity parameter, respectively, between the individual language-dependent phonemes can be used.

The method according to the invention is diagrammatically coarsely shown in FIG. 1. In the example of embodiment shown there are exactly two different speech data controlled assigning methods available, which are represented in FIG. 1 as method blocks 1, 2.

In the first one of the two speech data controlled assigning methods 1, HM models are generated for the phonemes Pₖ of the target language (in the following it is assumed that the target language M has different phonemes P₁ to P_{M}) while the speech data SD of the target language are used. Obviously, they are models which are still relatively degraded as a result of the limited speech data material of the target language. For these models of the target language a distance D to the HM basic phoneme models of all the basic phoneme units (PE₁, PE₂, . . . , P_{M}) is then calculated according to the above-described formulae. Each phoneme of the target language Pₖ is then assigned to the phoneme unit PEᵢ(Pₖ) whose basic phoneme model has the smallest distance to the phoneme model of the phoneme Pₖ of the target language.

In the second one of the two methods the incoming speech data SD are first segmented into individual phonemes. This so-called phoneme-start and phoneme-end segmenting is performed with the aid of a set of models for multilingual phonemes, which were defined in accordance with the international phonetic transcription SAMPA. The thus obtained segmented speech data of the target language then pass through a speech recognition system, which works on the basis of the set of phoneme units PE₁, . . . , PE_{N} to be assigned. The very phoneme units PEⱼ(Pₖ) that are recognized the most as the phoneme Pₖ by the speech recognition system are then assigned to the individual phonemes Pₖ of the target language which have evolved from the segmenting.

The same speech data SD and the same set of phoneme units PE₁, . . . , PE_{N} are thus used as input for the two methods.

After these two speech data controlled assigning methods 1, 2 have been implemented, exactly two assigned phoneme units Pᵢ(Pₖ) and PEⱼ(Pₖ) may then be selected for each phoneme Pₖ. The two speech data controlled assigning methods 1, 2 may further be implemented simultaneously but also consecutively.

In a next step 3 the phoneme units PEᵢ(Pₖ), PEⱼ(Pₖ) assigned by the two assigning methods 1, 2 are then compared for each phoneme Pₖ of the target language. If the two assigned phoneme units for the respective phoneme Pₖ are identical, this common assignment is simply assumed to be the last assigned phoneme unit PE_{Z}(Pₖ). Otherwise, in a next step 4, a selection is made from these phoneme units PEᵢ(Pₖ), PEⱼ(Pₖ) found via the automatic speech data controlled assigning methods.

This selection in step 4 is made on the basis of the phonetic background knowledge, while a relatively simple criterion which can be automatically applied is used. In particular, the selection is simply made so that exactly the phoneme unit is selected whose phoneme symbol or phoneme class, respectively, in the international phonetic notation SAMPA corresponds to the symbol or class, respectively, of the target language phoneme. For this purpose, first the phoneme units of the SAMPA symbols are to be assigned. This is effected while the symbols of the original, language-dependent phonemes, which the respective phoneme unit is made of, is reverted to. Moreover, obviously also the phonemes of the target languages are to be assigned to the international SAMPA symbols. This may be effected, however, in a relatively simple manner in that all the phonemes are assigned exactly to the symbols that symbolize this phoneme or are distinguished only by a length suffix “:”. Only individual units of the target language, for which there is no correspondence to the symbols of the SAMPA alphabet, are to be assigned to similar symbols that have the same sound. This may be done by hand or automatically.

As basic data are then obtained with the assigning method according to the invention a sequence of assignments PE_{Z1}(P₁), PE_{Z2}(P₂), . . . , PE_{ZM}(P_{M}) of phoneme units to the M possible phonemes of the target language, where Z₁, Z₂, . . . , ZM may be 1 to N. Each multilingual basic phoneme unit may then in principle be assigned to a plurality of phonemes of the target language.

To obtain for each of the target language phonemes its own separate start model for the generation of sets of M models for the target language phonemes, the basic phoneme model of the respective phoneme unit is re-generated X-1 times in cases where a multilingual phoneme unit is assigned to a plurality (X>1) of target language phoneme units. Furthermore, the models are removed of the unused phoneme units and phoneme units whose context depends on unused phonemes.

The start set of phoneme models thus obtained for the target language is adapted by means of a suitable adaptation technique. More particularly the customary adaptation techniques such as, for example, a Maximum a Posteriori (MAP) method (see, for example, C. H. Lee and J. L. Gauvain “Speaker Adaptation Based on MAP Estimation of HMM Parameters” in Proc. ICASSP, pp. 558-561, 1993), or a Maximum Likelihood Linear Regression method (MLLR) (see, for example, J. C. Leggetter and P. C. Woodland “Maximum Likelihood Linear Regression for Speaker Adaptation of Continuous Density Hidden Markov Models” in “Computer Speech and Language” (1995) 9, pp. 171-185) can be used. Obviously, also any other adaptation techniques may be used.

In this manner according to the invention really good models for a new target language can be generated even if there is only a small number of speech data available in the target language, which models are then available in their turn for forming sets of acoustic models to be used in speech recognition systems. The results obtained thus far with the above-mentioned example of embodiment show that the method according to the invention is clearly superior to both purely data-based and purely phonetic-transcription-based approaches for the definition and assignment of phoneme units. Although only half a minute each of spoken material of 30 speakers was available in the target language, a speech recognition system based on the models generated according to the invention for the miltilingual phoneme units (before an adaptation to the target language) could reduce the word error rate by about ¼ compared to the conventional methods.

1. A method of assigning phonemes (Pₖ) of a target language to a respective basic phoneme unit (PE_{Z}(Pₖ)) of a set of basic phoneme units (PE₁, PE₂, . . . , PE_{N}), which phoneme units are described by basic phoneme models, which models were generated based on available speech data of a source language, characterized by the following method steps:
implementing at least two different speech data controlled assigning methods (1, 2) for assigning the phonemes (Pₖ) of the target language to a respective basic phoneme unit (PEᵢ(Pₖ), PEⱼ(Pₖ)),
detecting whether the respective phoneme (Pₖ) was assigned to the same basic phoneme unit (PEᵢ(Pₖ), PEⱼ(Pₖ)) by a majority of the different speech data controlled assigning methods,
selecting as the basic phoneme unit (PE_{z}(Pₖ)) assigned to the respective phoneme (Pₖ) the basic phoneme unit (PEᵢ(Pₖ), PEⱼ(Pₖ)) assigned by the majority of the speech data controlled assigning methods (1, 2) insofar as a majority of the different speech data controlled assigning methods (1, 2) have a matching assignment,
or, otherwise, selecting a basic phoneme unit (PE_{z}(Pₖ)) from all the basic phoneme units (PEᵢ(Pₖ), PEⱼ(Pₖ)) which were assigned to the respective phoneme (Pₖ) by at least one of the different speech data controlled assigning methods (1, 2), while a similarity parameter is used in accordance with a symbol phonetic description of the phoneme (Pₖ) to be assigned and of the basic phoneme units (PEᵢ(Pₖ), PEⱼ(Pₖ)).

2. A method as claimed in claim 1, characterized
in that at least part of the basic phoneme units (PE₁, PE₂, . . . , PE_{N}) are multilingual phoneme units (PE₁, PE₂, . . . , PEN) which are formed by speech data of various source languages.

3. A method as claimed in claim 1 or 2, characterized
in that the similarity parameter in accordance with the symbol phonetic description contains information about an assignment of the respective phoneme (Pₖ) and about an assignment of the respective basic phoneme units (PEᵢ(Pₖ), PEⱼ(Pₖ)) to phoneme symbols and/or phoneme classes of a predefined phonetic transcription (SAMPA).

4. A method as claimed in one of the claims 1 to 3, characterized
in that with one of the speech data controlled assigning methods (1) in a first step using speech data (SD) of the target language, phoneme models are generated for the phonemes (Pₖ) of the target language, and then for all the basic phoneme units (PE₁, PE₂, . . . , PE_{N}) a respective difference of the basic phoneme model of the basic phoneme unit from the phoneme models of the phonemes (Pₖ) of the target language is determined, and the respective basic phoneme unit (PEᵢ(Pₖ)) that has the smallest difference parameter is assigned to the phonemes (Pₖ) of the target language.

5. A method as claimed in one of the claims 1 to 4, characterized
in that in a speech data controlled assigning method (2) speech data (SD) of the target language are segmented into individual phonemes (Pₖ) while phoneme models of a defined phonetic transcription are used, and for each of these phonemes (Pₖ) in a speech recognition system, which comprises the set of basic phoneme models of the basic phoneme units (PE₁, PE₂, . . . PE_{N}) to be assigned, recognition rates for the basic phoneme models are determined and to each phoneme (Pₖ) is assigned the basic phoneme unit (PEⱼ(Pₖ)) for whose basic phoneme model the best recognition rate was detected the most.

6. A method of generating phoneme models for phonemes of a target language to be implemented in automatic speech recognition systems for this target language, in which, in accordance with a method as claimed in one of the preceding claims, basic phoneme units are assigned to the phonemes of the target language, which basic phoneme units are described by respective basic phoneme models which were generated with the aid of available speech data of a source language different from the target language, and in which then for each target language phoneme the basic phoneme model of the assigned basic phoneme unit is adapted to the target language while the speech data of the target language are used.

7. A computer program with a program code means for carrying out all the steps as claimed in one of the preceding claims when the program is run on a computer.

8. A computer program with program code means as claimed in claim 7 which are stored on a data carrier that can be read by the computer.

9. A set of acoustic models to be used in automatic speech recognition systems, comprising a plurality of phoneme models generated in accordance with a method as claimed in claim 6.

10. A speech recognition system comprising a set of acoustic models as claimed in claim 9.
